(19) United States
(12) Patent Application Publication
(10) Pub. No.: US 2002/0145278 A1
(43) Pub. Date: Oct. 10, 2002

(54) Wear pad

(76) Inventors: Edward William Hulse, Staffordshire (GB); Roy William Allsopp, Staffordshire (GB)

Correspondence Address: MARSHALL, GERSTEIN & BORUN, 6300 SEARS TOWER, 233 SOUTH WACKER, CHICAGO, IL, 60606-6357, US

(21) Appl. No.: 10/104,584

(22) Filed: Mar. 22, 2002

(30) Foreign Application Priority Data
Mar. 24, 2001 (GB) 0107447.5

(51) Int. Cl. B60S 9/02

(52) U.S. Cl. 280/763.1

(57) ABSTRACT

A wear pad for a stabilizer leg, the wear pad comprising a first part to provide a wear surface and a second part comprising engagement means, wherein the first part comprises a first, relatively soft material and the second part comprises a second, relatively hard material.

### BACKGROUND OF THE INVENTION

This invention relates to a wear pad for a stabilizer leg for a vehicle and more particularly, but not exclusively, to stabilizing frames in or for excavators of the kind comprising an excavator assembly adapted for mounting on the stabilizing frame which is securable to the rear of a tractor or like vehicle wherein the excavator assembly comprises a boom pivotally mounted at its lower end for movement up and down in a vertical plane and carrying at its outer end a pivotally mounted dipper arm upon which is mounted an excavating tool such as a bucket, and wherein the boom is mounted also for traversing movement about a vertical axis so as to be capable of being swung from side-to-side of the centre line of the tractor, the frame having at each side an extensible leg member whereby, for example, when an excavator comprising such an excavator assembly, frame and tractor is operating upon uneven ground or soft ground or upon an inclination, the legs may be extended as required to ensure a firm support for the stabilizing frame.

An object of the invention is to provide a new and improved wear pad. Further objects of the invention are to provide a new and improved stabilizer leg and a new and improved stabilizing frame in or for an excavator of the kind above specified.

### SUMMARY OF THE INVENTION

According to a first aspect of the invention, we provide a wear pad for a stabilizer leg, the wear pad comprising a first part to provide a wear surface and a second part comprising engagement means, wherein the first part comprises a first, relatively soft material and the second part comprises a second, relatively hard material.

The first material may comprise a plastics material.

The plastics material may comprise nylon.

The nylon may be provided with a lubricant.

The second material may comprise metal, preferably steel.

The engagement means may comprise a external thread.

The second part may have a general cylindrical surface, the generally cylindrical surface being provided with said external thread.

The first part may be releasably attachable to said second part.

The first part and second part may be provided with interengaging connection means.

The wear pad may be provided with a socket to receive a tool whereby the wear pad may be rotated.

The socket may be a square or other non-circular section recess.

The socket may be provided in an end part of the second part.

According to a second aspect of the invention we provide a stabilizer leg comprising an upper outer part having telescopically slidable therein a lower inner part having a ground engageable portion and a wear pad according to the first aspect of the invention being adjustably engaged with one of said parts to permit of adjustment of clearance between the wear pad and an opposed surface of the other of said parts.

The wear pad may be adjustably engaged with the outer of said parts to permit of adjustment of clearance between the wear pad and the inner part.

The wear pad may be threadedly engaged with the outer part whereby rotation of the wear pad relative to the outer part causes relative movement between said wear pad and the outer part in a direction transverse to a direction in which said parts telescope.

Means may be provided to provide a frictional resistance to said relative threaded rotation.

The externally threaded part of the wear pad may be in said threaded engagement with an internally threaded part of said outer part.

One of said threaded parts, preferably the wear pad, may be provided with an insert for providing a frictional resistance to relative threaded rotation between the wear pad and said outer part.

The outer part may be provided with a boss and the boss may be provided with said internal thread.

The outer part may be provided with a further wear pad on a side thereof opposite to said adjustable wear pad.

The further wear pad may be fixed relative to the outer part or alternatively may also be adjustable in the same or a different manner to that of the first mentioned adjustable wear pad.

Where the leg is rectangular in section two adjacent sides of the outer part may be provided with an adjustable wear pad and the two opposite sides of the outer part may be provided with a further wear pad which may be fixed or adjustable.

In use, the provision of the wear pads ensures that the inner part telescopes relative to the outer part with a desired clearance between the inner part and the wear pads.

The desired clearance between the inner part and the wear pads may be maintained simply by rotating one or each of the wear pads, as necessary, by engagement of a suitable tool within the above mentioned recess to take up the desired wear.

Although in the above example, the case of a insert provided with a “stiff thread” is described if desired any other suitable means for constraining rotation of the wear pad relative to the outer part may be provided.

The upper part of the leg may be adapted to be fixed relative to a vehicle.

Two stabilizer legs may be adapted to be provided on opposite sides of a vehicle.

According to a third aspect of the invention we provide a stabilizing frame in or for an excavator of the kind specified wherein the frame has at each of two opposite sides a stabilizer leg according to the first aspect of the invention.

Preferably the stabilizer legs are inter-connected by cross rail means to provide the stabilizing frame.

The cross rail means may comprise a pair of cross rails one disposed adjacent a lower part of each outer part and the other provided thereabove but spaced downwardly from a top end of the outer part.

The cross rail means may provide guide ways for side shifting movement of a king post assembly which may carry an excavator assembly.

### BRIEF DESCRIPTION OF THE DRAWINGS

An embodiment of the invention will now be described by way of example with reference to the accompanying drawings wherein

FIG. 1 is a rear view of a stabilizing frame for an excavator,

FIG. 2 is a plan view of one of the legs of FIG. 1,

FIG. 3 is a section on the line 3-3 of FIG. 2,

FIG. 4 is a perspective view of a wear pad according to the present invention for use in the stabilizing frame and/or stabilizer leg described with reference to FIGS. 1 to 3,

FIG. 5 is a further perspective view of the wear pad of FIG. 4,

FIG. 6 is a section on the line 6-6 of FIG. 4, and

FIG. 7 is a perspective view of the rear of an excavator embodying the invention.

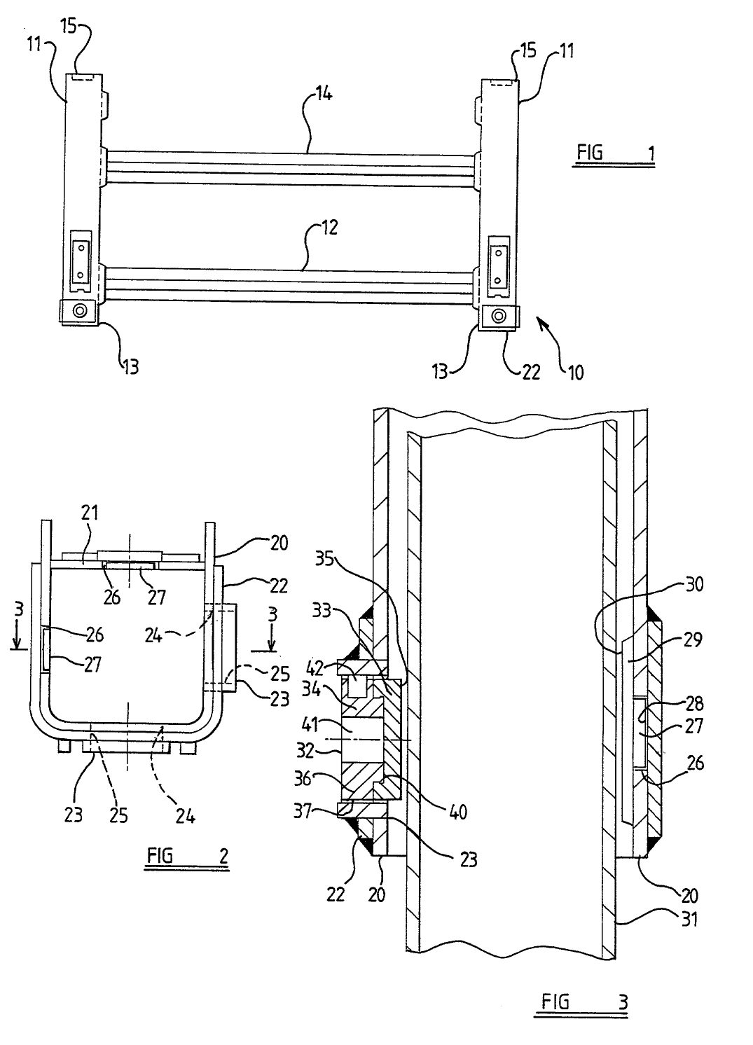

### DESCRIPTION OF THE PREFERRED EMBODIMENTS

Referring to the Figures a rear elevation of a stabilizing frame of an excavator is illustrated generally at 10 and comprises a pair of upper, outer, housing parts 11 inter-connected by a lower cross rail 12 disposed adjacent a lower end 13 of each housing 11 and an upper cross rail 14 disposed above the rail 12 and downwardly from an upper end 15 of the housing 11. The rails 12, 14 provide a guide means for a king post assembly 16 on which a conventional back-hoe type of excavator is mounted as best shown in FIG. 7.

The back-hoe excavator is mounted by the stabilizing frame 10 on the rear of a excavator vehicle 1 and comprises a bucket 2 pivotally mounted for movement in a vertical plane on a dipper arm 3 which in turn is pivotally mounted, again for movement in a vertical plane, on a boom 4. The inner end of the boom 4 is pivotally mounted, for movement in a horizontal and vertical plane, on the stabilizing frame 10 by means of the king post 16. Hydraulic rams 5 are provided to effect the various pivotal movements of the bucket and the dipper arm relative to the dipper arm and the boom respectively.

As best shown in FIG. 2 each housing part 11 is made as a U-shaped pressing 20 which is closed by a plate 21 welded across the open mouth thereof and extending longitudinally thereof. A reinforcing bracket, also of U-shaped cross-section is welded around the housing adjacent its lower end as shown at 22 and a pair of bosses 23 are welded in apertures 24 provided in the housing part 20 and the reinforcing bracket 22 so as to provide a pair of wear pad housings.

The bosses 23 providing the wear pad housings have an internally threaded passage 25.

Directly opposite each boss 23 the housing part 20 is provided with an aperture 26 whilst the reinforcing bracket 22 is not provided with an aperture at this position.

A fixed wear pad of a suitable material, in the present example a suitable self lubricated nylon, is shown at 27 and comprises a spigot part 28 received within the aperture 26 and an enlarged head part 29 having an inwardly facing surface 30 which is adapted to provide a wear surface for an inner, lower leg, part 31 of the stabilizer.

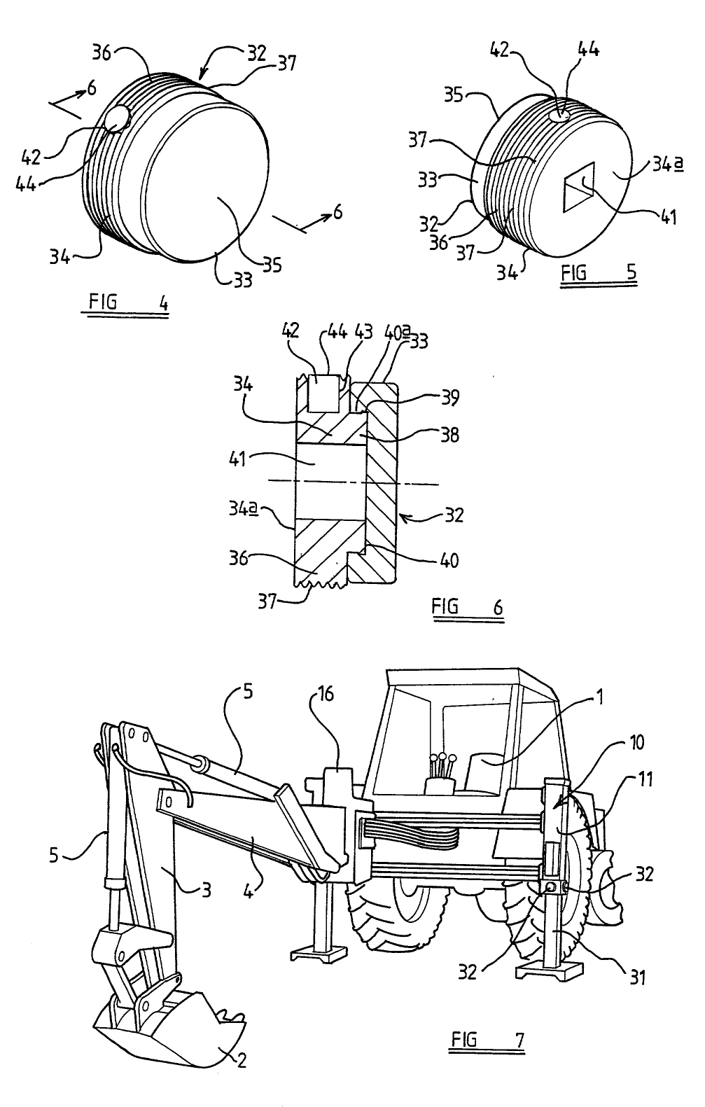

An adjustable wear pad according to a first aspect of the present invention is shown at 32 in FIGS. 4 to 6. The wear pad 32 comprises a first part 33 and a second part 34. The first part 33 is generally cylindrical in appearance, with an end face 35 thereof providing an operative wear surface. The first part 33 preferably comprises a relatively soft material, such as a plastics material such as nylon and preferably a self lubricating nylon.

The second part 34 comprises a cylindrical part 36 having a generally cylindrical outer surface provided with an external thread 37. The second part 34 is preferably made of a relatively hard material, such as a metal and preferably steel.

Interengaging connection means are provided to hold the first part 33 and the second part 34 in engagement. The second part 34 is provided with a projecting part 38 which in the present example is generally cylindrical and of a smaller diameter than the cylindrical part 36. At an outer end thereof the projecting part 38 is provided with a lip 39. The projecting part 38 is received in a corresponding blind recess 40 provided in the first part 33. The recess 40 is provided with an inwardly directed flange 40a at its periphery. The dimensions of the projecting part 38 and lip 39 and recess 40 and flange 40a are such that they interengage in a snap-fit fashion such that the first part 33 and second part 34 are firmly connected. In the preferred example, where the first part 33 comprises a desired relatively soft material such as nylon, the first part 33 can be resiliently deformed sufficiently to pass the flange 40a over the lip 39.

It will be apparent that any other suitable interengaging connection means may be provided as described.

The adjustable wear pad 32 has a socket 41 of a suitable non-circular shape, in the present example of square cross section, for receiving a suitable tool such as a standard socket set bar, whereby the adjustable wear pad 32 may be rotated relative to the boss 23 and so as to move the operative wear surface 35 of the wear pad 32 transversely of the direction of telescopic movement between the inner and outer leg parts relatively to an opposed surface of inner leg part 31. In the present example, the socket 41 extends through the second part 34 from an end face 34a, but may of course comprise a blind recess if desired.

The adjustable wear pad 32 is provided with a stiff thread facility whereby resistance to rotation is provided and in particular inadvertent rotation in service is resisted. In the present example, this is provided by means of a generally radially disposed plug 42 received in a recess 43 of cylindrical configuration. The plug 42 is peripherally made of a suitable synthetic plastics material, in this case nylon 6, and is preferably provided with a plain operative surface 44 and is dimensioned so as to be an interference fit with the internal thread of the boss 23, thus providing a resistance to relative rotation of the wear pad 32 and the boss 23.

In use the external thread 37 engages an internal thread of the boss 23. When it is desired to adjust the clearance between the inner and outer leg parts, the or each adjustable wear pad 32 is rotated until the inner leg part 31 is clamped against the opposed fixed wear pad and then they are backed off an appropriate amount, in the present example ¼ of a turn, the thread being of 3 mm pitch. Such adjustment is quick and simple.

It will be apparent that as the first part 33 of the wear pad 32 is gradually worn away in service, the wear pad 32 can be rotated to maintain the desired clearance between the inner and outer leg parts by engagement of a tool with a socket 41. When the first part 33 of the wear pad 32 has worn to such an extent that it becomes desirable to replace the wear pad 32, it will be apparent that this may be achieved simply by unscrewing the wear pad 32 from the boss 23, removing the old first part 33 and snapping on a replacement new part 33. The wear pad 32 may then be screwed back into the boss and adjusted as described above.

Since the wear pad 32 comprises a relatively hard second part 34 provided with a thread 37 to engage the boss 23, the risk of foreign materials being introduced between the housing part 11 and the inner leg part 31 as a result of deformation of the wear pad 32 is reduced. It is known that where a wear pad 32 entirely comprises a softer material, deformation of the wear pad 32, particularly as a result of the plug 42, can lead to clearance developing between the wear pad 32 and the internal thread of the boss 23 permitting the entry of foreign bodies into the housing part 11.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A wear pad for a stabilizer leg, the wear pad comprising a first part to provide a wear surface and a second part comprising engagement means, wherein the first part comprises a first, relatively soft material and the second part comprises a second, relatively hard material.

2. A wear pad according to claim 1 wherein the first relatively soft material comprises a plastics material.

3. A wear pad according to claim 2 wherein the plastics material comprises nylon provided with a lubricant.

4. A wear pad according to claim 1 wherein the second material comprises metal such as steel.

5. A wear pad according to claim 1 wherein the second part has a generally cylindrical surface and said cylindrical surface is provided with an external thread.

6. A wear pad according to claim 5 wherein the second part is provided with an insert for providing a frictional resistance to relative threaded rotation between the wear pad and an internally threaded part.

7. A wear pad according to claim 1 wherein the first part is releasably attachable to said second part.

8. A wear pad according to claim 7 wherein the first part and the second part are provided with inter-engaging connection means.

9. A wear pad according to claim 1 provided with a socket to receive a tool whereby the wear pad may be rotated the socket being provided in an end part of said second part.

10. A stabilizer leg comprising an upper outer part having telescopically slidable therein a lower inner part having a ground engageable portion and a wear pad being adjustably engaged with one of said parts to permit adjustment as clear as between the wear pad and an oppose surface of the other said parts, the wear pad comprising a first part to provide a wear surface and a second part comprising engagement means, wherein the first part comprises a first, relatively soft material and the second part comprises a second, relatively hard material.

11. A stabilizer leg according to claim 10 wherein the wear pad is adjustably engaged with the outer of said parts to permit of adjustment of clearance between the wear pad and the inner part.

12. A stabilizer leg according to claim 11 wherein the wear pad is threadedly engaged with the outer part whereby rotation of the wear pad relative to the outer part causes relative movement between said wear pad and the outer part in a direction transverse to a direction in which said parts telescope.

13. A stabilizer leg according to claim 12 wherein the second part of the wear pad has on external thread and wherein the external thread of the wear pad is in threaded engagement with an internally threaded part of said outer part.

14. A stabilizer leg according to claim 13 wherein the outer part is provided with a boss and the boss is provided with said internally threaded part.

15. A stabilizer leg according to claim 10 wherein the outer part is provided with a further wear pad on a side thereof opposite to said adjustable wear pad.

16. A stabilizer leg according to claim 10 wherein the leg is rectangular in section and wherein two adjacent sides of the outer part are provided with an adjustable wear pad.

17. A stabilizing frame in or for an excavator of the kind specified wherein the frame has at each of two opposite sides a stabilizer leg comprising a stabilizer leg comprising an upper outer part having telescopically slidable therein a lower inner part having a ground engageable portion and a wear pad being adjustably engaged with one of said parts to permit adjustment as clear as between the wear pad and an oppose surface of the other said parts, the wear pad comprising a first part to provide a wear surface and a second part comprising engagement means, wherein the first part comprises a first, relatively soft material and the second part comprises a second, relatively hard material

18. A stabilizing frame according to claim 17 wherein the stabilizer legs are inter-connected by cross rail means to provide the stabilizing frame.

19. A stabilizing frame according to claim 18 wherein the cross rail means comprises a pair of cross rails one disposed adjacent a lower part of each outer part and the other provided thereabove but spaced downwardly from a top end of the outer part.

20. A stabilizing frame according to claim 18 wherein the cross rail means provides guide ways for side shifting movement of a king post assembly which may carry an excavator assembly.
